(19) United States
(12) Patent Application Publication
(10) Pub. No.: US 2015/0264010 A1
(43) Pub. Date: Sep. 17, 2015

(54) INTERNET PROTOCOL VERSION 6 ADDRESS CONFIGURATION METHOD

(71) Applicant: ELECTRONICS AND TELECOMMUNICATIONS RESEARCH INSTITUTE, Daejeon (KR)

(72) Inventors: Jung-Soo PARK, Daejeon (KR); Myung-Ki SHIN, Seoul (KR)

(21) Appl. No.: 14/643,012

(22) Filed: Mar. 10, 2015

(30) Foreign Application Priority Data
Mar. 11, 2014 (KR) 10-2014-0028223

(51) Int. Cl. H04L 29/12; H04L 29/08

(52) U.S. Cl. CPC H04L 61/6059; H04L 61/609; H04L 67/18

(57) ABSTRACT

Disclosed herein is an IPv6 address configuration method, provide an IPv6 address configuration method, which assigns IPv6 addresses to a plurality of users who use an Internet service in a smart stadium network. The presented method includes, in a network including a router and an access point, sending, by the router, a router advertisement message including IPv6 prefix information to a user device equipped with a reader through the access point; acquiring, by the user device, unique information of the user from an object including the unique information of the user; and configuring, by the user device, a unique IPv6 address by combining the IPv6 prefix information with the unique information of the user.

### CROSS REFERENCE TO RELATED APPLICATION

This application claims the benefit of Korean Patent Application No. 10-2014-0028223 filed Mar. 11, 2014, which is hereby incorporated by reference in its entirety into this application.

### BACKGROUND OF THE INVENTION

1. Technical Field

The present invention generally relates to an Internet Protocol version 6 (IPv6) address configuration method and, more particularly, to a method that assigns IPv6 addresses to a plurality of users who simultaneously use an Internet service in a stadium such as a baseball stadium or a soccer stadium.

2. Description of the Related Art

IPv6, which is the abbreviation of Internet protocol version 6, refers to a new IP address system that has been developed to solve the disadvantages of IPv4 that is an IP address system currently in use.

IPv6 is the core technology of next generation Internet for which a data processing speed, a simultaneous data processing capacity, an Internet address system, etc. are remarkably extended compared to IPv4.

Conventional technology to which such IPv6 is applied includes the Internet draft “Centrally Assigned Unique Local IPv6 Unicast Addresses” (draft-ietf-ipv6-ula-central-02.txt, 2007. 6). In this document, centrally assigned IPv6 unique local addresses are defined. The assigned IPv6 unique local addresses are intended for local communications, but are globally unique. However, IPv6 unique local addresses must not be used in a routing table. As shown in FIG. 1, the format (structure) of this address includes a prefix field, an L field, a global identifier (ID) field, and an interface ID field.

In FIG. 1, as the prefix field, FC00::/7 prefix is used and is used to designate local IPv6 unicast addresses. The prefix field has a 7-bit length.

The L field is set to “0” when a prefix is centrally allocated, whereas it is set to “1” when the prefix is locally allocated. In FIG. 1, since the prefix is centrally allocated, the L field will be set to “0”. The L field has a 1-bit length.

The global ID field is a 40-bit global identifier used to generate a globally unique prefix.

The subnet ID field is a 16-bit identifier used to identify a single subnet in a site.

The interface ID field is an interface identifier constituting lower 64 bits of an IPv6 address, and is generally and widely configured using an Extended Unique Identifier (EUI)-64 format including a 2-layer Media Access Control (MAC) address.

Meanwhile, another conventional technology to which IPv6 is applied includes Internet draft “Centrally Assigned IPv6 Unicast Unique Local Address Prefixes” (draft-hain-ipv6-ulac-02, 2010. 7). In this document, centrally assigned IPv6 unicast local address prefixes are defined. These prefixes are globally unique, but are intended for local communications and are generally used in a single network management domain. In particular, unlike IPv6 Provider Independent (PI) unicast addresses assigned via Regional Internet Registry (RIR), these prefixes must not be included in a global routing table on the Internet.

Here, prefixes are centrally allocated, so that they are used only for local communications in a specific area while the uniqueness thereof is guaranteed. Therefore, the prefixes may support Internet services for which users are temporarily concentrated in a specific area.

As related preceding technology, Korean Patent Application Publication No. 2004-0097455 (entitled “Apparatus for Configuring Internet Protocol Address of IPv6 Host and Method thereof and Internet Service Method Using the Internet Protocol Address”) discloses technology for automatically configuring unicast and multicast addresses of an IPv6 host using local information.

### SUMMARY OF THE INVENTION

Accordingly, the present invention has been made keeping in mind the above problems occurring in the prior art, and an object of the present invention is to provide an IPv6 address configuration method, which assigns IPv6 addresses to a plurality of users who use an Internet service in a smart stadium network.

In accordance with an aspect of the present invention to accomplish the above object, there is provided an Internet Protocol version 6 (IPv6) address configuration method, including, in a network including a router and an access point, sending, by the router, a router advertisement message including IPv6 prefix information to a user device equipped with a reader via the access point; acquiring, by the user device, unique information of the user from an object including the unique information of the user; and configuring, by the user device, a unique IPv6 address by combining the IPv6 prefix information with the unique information of the user.

The unique IPv6 address may include a prefix field, an L field, a PQ field indicating whether the unique Pv6 address is used for a public or private purpose, a global identifier (ID) field required to classify services for respective purposes, a subnet ID field including information indicative of a level of the user, and a location ID field including location information of the user.

The information indicative of the level of the user may include a class of the user's seat and floor information of the seat.

The location information of the user may include any one of latitude and longitude of the user and a seat number of the user.

The PQ field may have a 2-bit length.

The global ID field may have a 38-bit length.

The location ID field may have a 64-bit length.

The unique information of the user may include one or more of the location information of the user and class information of the user's seat.

The IPv6 address configuration method may further include, after configuring the unique IPv6 address, sending, by the user device, an Internet connection request message including the unique information of the user to the router via the access point; requesting, by the router, a server connected to the network to verify validity of the user by sending the Internet connection request message to the server; registering, by the server, the user when the server verifies validity of the user and succeeds in verification; and sending, by the server, a response message to the verification of validity of the user, to the user device via the router and the access point.

In accordance with another aspect of the present invention, there is provided an Internet Protocol version 6 (IPv6) address configuration method, including, in a network including a router, an access point, an independent reader, and a server, sending, by the router, a router advertisement message including IPv6 prefix information to a user device equipped with no reader via the access point; acquiring, by the independent reader, unique information of the user from an object including the unique information of the user; requesting, by the independent reader, the server to check validity of the user by sending the unique information of the user to the server; registering, by the server, the user, and providing a response message to the independent reader when the server checks validity of the user and succeeds in checking; providing, by the independent reader, the unique information of the user to the user device; and configuring, by the user device, a unique IPv6 address by combining the IPv6 prefix information with the unique information of the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the structure of a unique local IPv6 address employed in a conventional central assignment scheme for unique IPv6 unicast addresses;

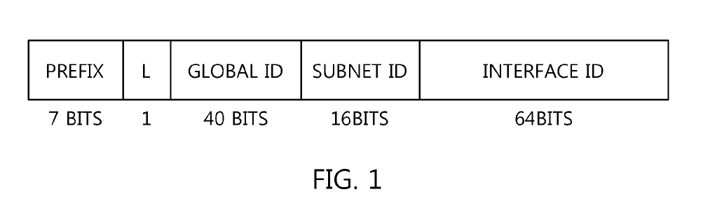

FIG. 2 is a configuration diagram of a smart stadium network to which the present invention is applied;

FIG. 3 is a diagram showing the structure of an IPv6 address employed in an embodiment of the present invention;

FIG. 4 is a flowchart showing a procedure for assigning an IPv6 address to a user having a reader in an IPv6 address configuration method according to an embodiment of the present invention; and

FIG. 5 is a flowchart showing a procedure for assigning an IPv6 address to a user having no reader in the IPv6 address configuration method according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

In the specification of the present invention, a smart stadium environment is configured such that unspecified individuals are temporarily gathered, a plurality of users are continuously changed every moment, and new users are gathered. Simultaneously with this, each user acts as a personal broadcasting station that must transmit a large amount of real-time data simultaneously produced in a stadium so as to be provided with an Internet service from the outside of the stadium.

Therefore, the smart stadium network must allow a plurality of users to use an Internet service (e.g., data downloading, web browsing, etc.) in real time and must have excellent network performance so that a large amount of multimedia data may be simultaneously uploaded. Further, the smart stadium network is composed of users, a wired/wireless host such as a kiosk for ticket selling and guidance service, a user data management server, and routers for connection to the outside. Furthermore, the smart stadium network must use IPv6 technology for smooth address assignment service.

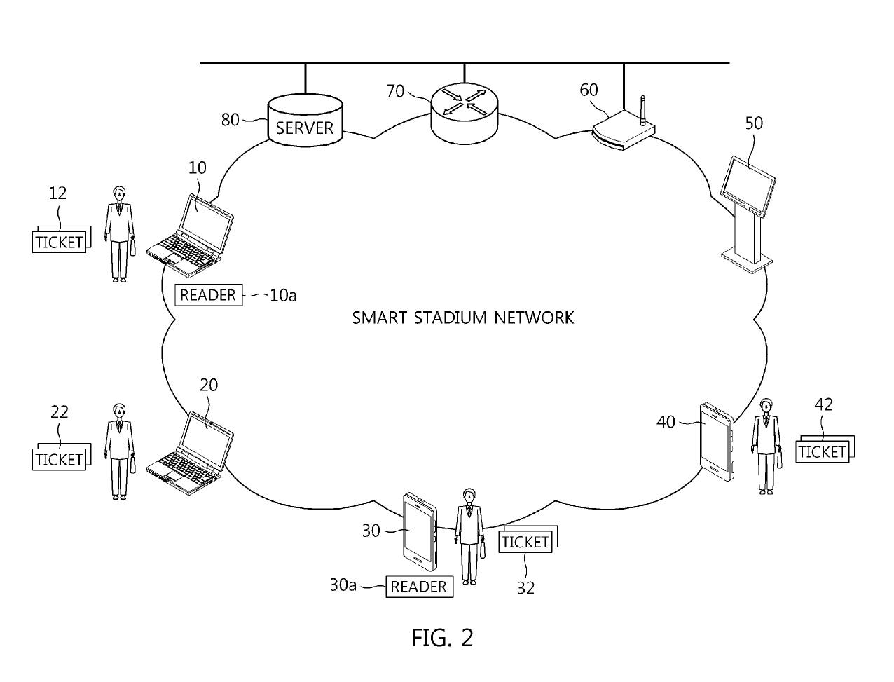

FIG. 2 is a configuration diagram of a smart stadium network to which the present invention is applied. Such a network structure may also be variously utilized in home networks as well as in smart stadiums.

An access point (AP) 60, a router 70, and a server 80 are connected to the smart stadium network.

Further, users having devices 10 and 30 equipped with readers 10a and 30a, respectively, and users having devices 20 and 40 equipped with no readers may perform wireless communication with the router 70 of the smart stadium network by using their own devices.

In FIG. 2, although the reader 10a and the reader 30a are shown as being located separately from the devices 10 and 30, respectively, it should be understood that the reader 10a is actually installed in the device 10, and the reader 30a is installed in the device 30. Further, the devices 10, 20, 30, and 40 need only to be electronic devices that are portable and enable wireless communication, for example, a mobile phone, a smart phone, a notebook computer, etc.

Here, the reader 10a may read the unique information of the user contained in a ticket 12 (e.g., location information, user class information, etc.), and the reader 30a may read the unique information of the user contained in a ticket 32. Accordingly, each of the devices 10 and 30 may automatically configure a unique IPv6 address by combining prefix information included in a Router Advertisement (RA) message, received from the router 70 via the access point 60, with the unique information of the corresponding user acquired from the ticket 12 or 32 of the user. That is, each device 10 or 30 may be regarded as being equipped with a module (not shown) capable of automatically configuring a unique IPv6 address.

Meanwhile, the independently installed reader 50 may acquire the unique information of each user included in a ticket 22 or 42 (e.g., location information, user class information, etc.). Accordingly, the user having the device 20 or 40 equipped with no reader acquires his or her unique information (e.g., location information, user class information, etc.) via the independent reader 50 connected to the smart stadium network. That is, the reader 50 provides the acquired unique information of the user to the user device 20 or 40, and the user device 20 or 40 may automatically configure a unique IPv6 address by combining prefix information included in a Router Advertisement (RA) message, received from the router 70 via the access point 60, with the unique information of the user received from the reader 50. Each of the devices 20 and 40 may be understood to be equipped with a module (not shown) capable of automatically configuring a unique IPv6 address.

Each of the above-described tickets 12, 22, 32, and 42 may be an example of an object described in the accompanying claims of the present invention.

In the above-described smart stadium environment, IPv6 addresses including location information and user class information may be configured, and an Internet service may be provided based on the IPv6 addresses. The router 70 provides a function of hiding location information, such as latitude and longitude, and the class information of the user. Further, the router 70 performs an IPv6 conversion function depending on a security policy.

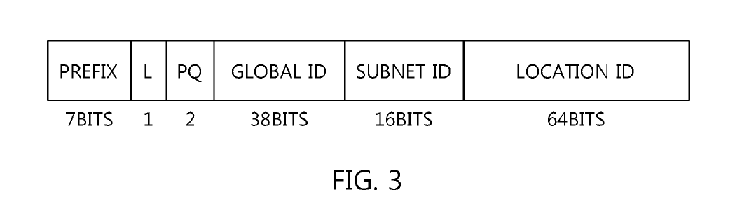

FIG. 3 is a diagram showing the structure of an IPv6 address employed in an embodiment of the present invention.

An IPv6 address employed in the embodiment of the present invention includes a 7-bit prefix field, a 1-bit L bit, a 2-bit PQ field, a 38-bit global ID field, a 16-bit subnet ID field, and a 64-bit location ID field.

Here, the prefix field is implemented using a FC00::/7 prefix, and is used to designate a local IPv6 unicast address.

The L field indicates that an IPv6 prefix is centrally allocated and is set to “0”.

The PQ field indicates whether an IPv6 address is used for public or private purpose. For example, a value of “00” denotes a public purpose, and a value of “10” denotes a private purpose. Meanwhile, values of “01” and “11” indicate preliminary values.

The global ID field is allocated by a government-managed institution when the value of the PQ field is “00”. In contrast, when the value of the PQ field is “10”, the purpose of the IPv6 address is a private purpose, and thus the value of the global ID field may be freely set. The values of the global ID field (38-bit values) are classified into various topics, which are denoted by, for example, “public/disaster/mountain”, and have bitstreams mapped thereto.

The subnet ID field includes information indicative of the level of the user (sender). The information indicative of the level of the user indicates that the user is an authorized user. The information indicative of the level of the user is acquired via a two-dimensional (2D) barcode, Near-Field Communication (NFC) communication, etc., and includes information about the class of the user's seat, floor information of the seat, etc. The information indicative of the level of the user is stored, together with unique information presented by the user in a procedure of purchasing the ticket 12, 22, 32 or 42, in the server 80. Thereafter, the information indicative of the level of the user is used to verify validity when inquiring the server 80 about the validity of the user using the unique information of the user.

The location ID field constitutes lower 64 bits of an IPv6 address, and includes the location information of the user (e.g., latitude and longitude, a seat number, etc.). Here, when the location information of the user includes seat information, it is locally unique, and thus IPv6 conversion must be provided via the router 70. Meanwhile, a service provided when the location information of the user includes latitude and longitude information enables the tracking of a location where information is generated because location information is included in an IPv6 address.

In this way, an IPv6 address employed in the embodiment of the present invention includes public/private use identification information, information about the classification of services for respective purposes, the level information of the user (sender), and the location information of the user in an IPv6 address so as to improve the utilization of the IPv6 address.

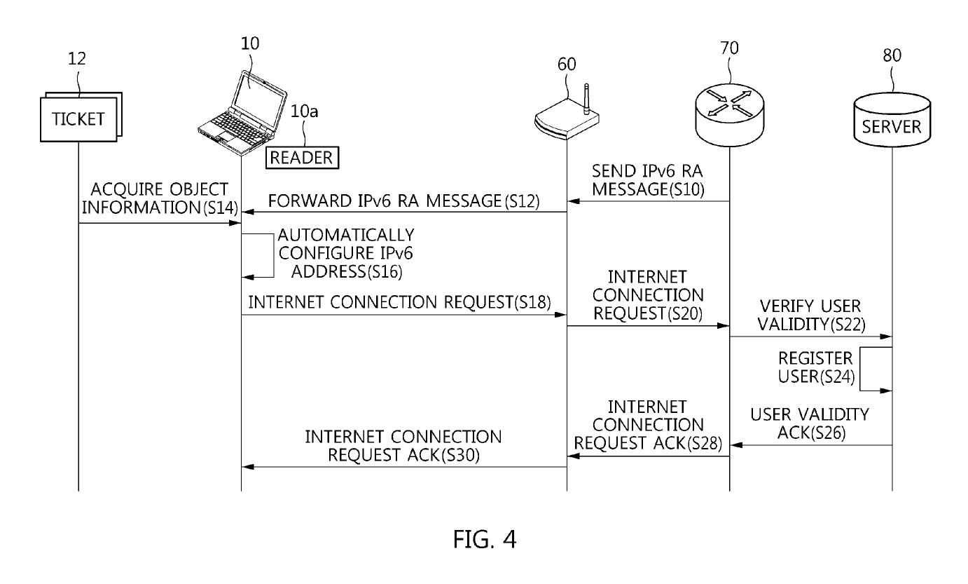

FIG. 4 is a flowchart showing a procedure for assigning an IPv6 address to a user having a reader in a location-based IPv6 address configuration method according to an embodiment of the present invention. In FIG. 4, a case where a user uses a device 10 equipped with a reader 10a is assumed.

A ticket 12 includes seat information uniquely allocated to the corresponding user and the class information of the seat. Such information may be delivered to the user using various methods, such as Near-Field Communication (NFC), Radio Frequency Identification (RFID), and a barcode.

First, a router 70 periodically sends a Router Advertisement (RA) message for the configuration of an IPv6 address to the access point 60 at step S10.

A section between the access point 60 and the user device 10 is a wireless section, in which wireless Local Area Network (LAN) or mobile communication technology may be utilized. The access point 60 forwards the RA message to the user device 10 via the wireless section at step S12. Consequently, the RA message provides IPv6 prefix information to the user.

Then, the user device 10 acquires the unique information of the user (location information, user class information, etc.) included in the ticket 12 via the reader 10a at step S14. Here, a scheme that is used for information acquisition may be any of various schemes, such as a barcode, NFC, and RFID.

Thereafter, the user device 10 automatically configures a unique IPv6 address (see FIG. 3) by combining the IPv6 prefix information acquired at step S12 with the unique information of the user acquired from the ticket 12 at step S16.

Next, the user device 10 transfers an Internet connection request message through the wireless section so as to verify whether the automatically configured IPv6 address is unique and is usable at step S18. In this case, the user device 10 provides the unique information of the user (location information, user class information, etc.) together with the request message.

The router 70 receives the Internet connection request message, transferred through the wireless section, via the access point 60 at step S20.

Accordingly, the router 70 requests the server 80 to verify the validity of the user at step S22. In this case, the router 70 provides the unique information of the corresponding user (location information, user class information, etc.) together with the request.

The server 80 verifies the validity of the user by comparing the received unique information of the user with its own stored information. If verification has succeeded, the server 80 finally registers the user at step S24. From that point on, an environment in which the user is capable of using an Internet service is constructed.

After the registration of the user has been completed, the server 80 returns the results of verifying the user validity to the router 70 at step S26. In this way, if the verification of the user validity has succeeded, the router 70 sets a routing table, thus forming an environment enabling the Internet service to be provided. Here, two methods are used. A first method is implemented such that an IPv6 address conversion technique is installed in the router 70 to perform a conversion function when the automatically generated IPv6 address is only locally used. A second method is to merely update the routing table when the generated IPv6 address is globally used.

Thereafter, the router 70 sends a response message (i.e., Internet connection request Acknowledgement (ACK)) to the access point 60 at step S28.

Further, the access point 60 forwards the response message (i.e., the Internet connection request ACK) to the user device 10 at step S30. Accordingly, the user may use the Internet service from that point on.

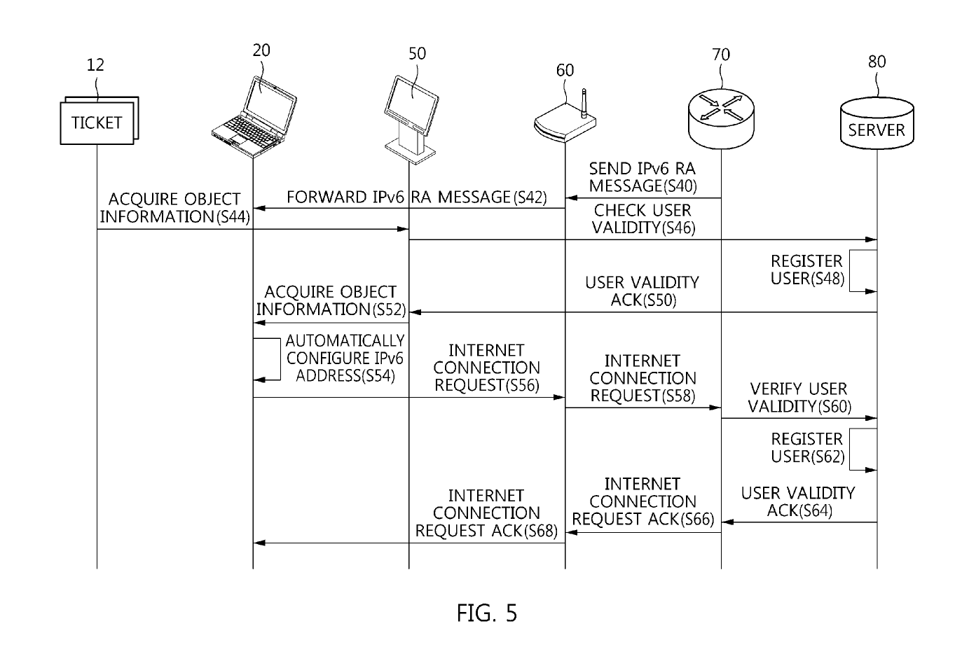

FIG. 5 is a flowchart showing a procedure for assigning an IPv6 address to a user having no reader in the location-based IPv6 address configuration method according to an embodiment of the present invention. That is, in FIG. 5, a case where a user uses a device 20 equipped with no reader is assumed.

First, the router 70 periodically sends an RA message for the configuration of an IPv6 address to the access point 60 at step S40.

A section between the access point 60 and the user device 20 is a wireless section, in which wireless LAN or mobile communication technology may be utilized. The access point 60 forwards the RA message to the user device 20 through the wireless section at step S42. Consequently, the RA message provides IPv6 prefix information to the user.

Further, the reader 50 acquires the unique information of the user (location information, user class information, etc.) contained in a ticket 22 either by bringing the ticket 22 into contact with the reader 50 or in a non-contact manner at step S44.

Thereafter, the reader 50 directly requests the server 80 to check the validity of the user at step S46. In this case, the reader 50 provides the unique information of the user (location information, user class information, etc.) together with the request.

Then, the server 80 performs a user registration procedure depending on the results of checking the user validity at step S48.

Thereafter, the server 80 transfers information about the results of checking the user validity to the reader 50 at step S50.

When the validity checking result information exhibits a success in the checking of the user validity, the reader 50 provides the unique information of the user acquired from the above-described procedure at step S44 to the user device 20 at step S52. This procedure may be implemented using communication such as typical NFC. In an environment in which security is not emphasized, information indicated on the reader 50 may be simply read by the user with his or her naked eyes.

Then, the user device 20 automatically configures a unique IPv6 address (see FIG. 6) by combining the IPv6 prefix information acquired at the above-described step S42 with the unique information of the user acquired from the reader 50 at step S54.

Thereafter, the user device 20 sends an Internet connection request message through a wireless section so as to verify whether the automatically configured IPv6 address is unique and is usable at step S56. In this case, the user device 20 provides the unique information of the user (location information, user class information, etc.), together with the request message.

The router 70 receives the Internet connection request message, transferred through the wireless section, via the access point 60 at step S58.

Accordingly, the router 70 requests the server 80 to verify the validity of the user at step S60. In this case, the router 70 provides the unique information of the corresponding user (location information, user class information, etc.) together with the request.

The server 80 verifies the validity of the user by comparing the received unique information of the user with its own stored information. If the verification of user validity has succeeded, the server 80 finally registers the user at step S62. From that point on, an environment in which an Internet service may be used is constructed.

After the procedure at step S62, the server 80 returns the results of verifying the user validity to the router 70 at step S64. In this way, when the verification of user validity has succeeded, the, router 70 sets a routing table and forms an environment enabling the Internet service to be provided.

Thereafter, the router 70 sends a response message (i.e., Internet connection request ACK) to the access point 60 at step S66.

Further, the access point 60 forwards the response message (i.e., Internet connection request ACK) to the user device 20 at step S68. Accordingly, the user may use the Internet service from that point on.

Of course, since the user verification and registration procedure has been previously processed by the reader 50, the above-described procedure at steps S56 to S68 may be omitted.

In accordance with the present invention having the above configuration, public and private purpose information and location information are included in IPv6 addresses, and thus the misuse and abuse of IPv6 addresses may be prevented, and new Internet services may be developed.

Further, the present invention enables IPv6 addresses, which are generated to be used only in a specific area, to be globally used, and also allows the locations of users who create services to be tracked because the IPv6 addresses include information such as latitude and longitude.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An Internet Protocol version 6 (IPv6) address configuration method, comprising:
in a network including a router and an access point, sending, by the router, a router advertisement message including IPv6 prefix information to a user device equipped with a reader via the access point;
acquiring, by the user device, unique information of the user from an object including the unique information of the user; and
configuring, by the user device, a unique IPv6 address by combining the IPv6 prefix information with the unique information of the user.

2. The IPv6 address configuration method of claim 1, wherein the unique IPv6 address includes a prefix field, an L field, a PQ field indicating whether the unique Pv6 address is used for a public or private purpose, a global identifier (ID) field required to classify services for respective purposes, a subnet ID field including information indicative of a level of the user, and a location ID field including location information of the user.

3. The IPv6 address configuration method of claim 2, wherein the information indicative of the level of the user includes a class of the user's seat and floor information of the seat.

4. The IPv6 address configuration method of claim 2, wherein the location information of the user includes any one of latitude and longitude of the user and a seat number of the user.

5. The IPv6 address configuration method of claim 2, wherein the PQ field has a 2-bit length.

6. The IPv6 address configuration method of claim 2, wherein the global ID field has a 38-bit length.

7. The IPv6 address configuration method of claim 2, wherein the location ID field has a 64-bit length.

8. The IPv6 address configuration method of claim 1, wherein the unique information of the user includes one or more of the location information of the user and class information of the user's seat.

9. The IPv6 address configuration method of claim 1, further comprising, after configuring the unique IPv6 address:
sending, by the user device, an Internet connection request message including the unique information of the user to the router via the access point;
requesting, by the router, a server connected to the network to verify validity of the user by sending the Internet connection request message to the server;
registering, by the server, the user when the server verifies validity of the user and succeeds in verification; and
sending, by the server, a response message to the verification of validity of the user, to the user device via the router and the access point.

10. An Internet Protocol version 6 (IPv6) address configuration method, comprising:
in a network including a router, an access point, an independent reader, and a server, sending, by the router, a router advertisement message including IPv6 prefix information to a user device equipped with no reader via the access point;
acquiring, by the independent reader, unique information of the user from an object including the unique information of the user;
requesting, by the independent reader, the server to check validity of the user by sending the unique information of the user to the server;
registering, by the server, the user, and providing a response message to the independent reader when the server checks validity of the user and succeeds in checking;
providing, by the independent reader, the unique information of the user to the user device; and
configuring, by the user device, a unique IPv6 address by combining the IPv6 prefix information with the unique information of the user.

11. The IPv6 address configuration method of claim 10, wherein the unique IPv6 address includes a prefix field, an L field, a PQ field indicating whether the unique Pv6 address is used for a public or private purpose, a global identifier (ID) field required to classify services for respective purposes, a subnet ID field including information indicative of a level of the user, and a location ID field including location information of the user.

12. The IPv6 address configuration method of claim 11, wherein the information indicative of the level of the user includes a class of the user's seat and floor information of the seat.

13. The IPv6 address configuration method of claim 11, wherein the location information of the user includes any one of latitude and longitude of the user and a seat number of the user.

14. The IPv6 address configuration method of claim 11, wherein the PQ field has a 2-bit length.

15. The IPv6 address configuration method of claim 11, wherein the global ID field has a 38-bit length.

16. The IPv6 address configuration method of claim 11, wherein the location ID field has a 64-bit length.

17. The IPv6 address configuration method of claim 10, wherein the unique information of the user includes one or more of the location information of the user and class information of the user's seat.

18. The IPv6 address configuration method of claim 10, further comprising, after configuring the unique IPv6 address:
sending, by the user device, an Internet connection request message including the unique information of the user to the router via the access point;
requesting, by the router, the server to verify validity of the user by sending the Internet connection request message to the server;
registering, by the server, the user when the server verifies validity of the user and succeeds in verification; and
sending, by the server, a response message to the verification of validity of the user, to the user device via the router and the access point.
